(19) United States
(12) Patent Application Publication
(10) Pub. No.: US 2022/0374960 A1
(43) Pub. Date: Nov. 24, 2022

(54) INTEGRATED STYLE PROFILE

(71) Applicant: CurioSearch dba MATERIALL, Milpitas, CA (US)

(72) Inventors: Anand Ramani, Pleasanton, CA (US); Karpagam Gobalakrishna, Pleasanton, CA (US); BHARAT VIJAY, Fremont, CA (US); ROHIT JAIN, Danville, CA (US)

(73) Assignee: CurioSearch DBA Materiall, MILPITAS, CA (US)

(21) Appl. No.: 17/314,331

(22) Filed: May 7, 2021

Related U.S. Application Data
(63) Continuation-in-part of application No. 17/308,203, filed on May 5, 2021.

(51) Int. Cl. G06Q 30/06; G06F 16/955

(52) U.S. Cl. CPC G06Q 30/0631; G06Q 30/0643; G06Q 30/0629; G06F 16/955

(57) ABSTRACT

Described herein is a method and system for collective shopping wherein one or more than one user is involved in the decision making process of an online purchase. The style profile is built for each individual contributor by exposing them to a set of product images and analysing their inputs about their preferences. The analysis is performed at an attribute level to understand each style aesthetic in a deep and meaningful manner. A backend algorithm runs on the attribute level feedback given by each contributor to calculate their combined style performance at an attribute and product level. This input is taken and run across the annotated online catalogue to surface products that fit the style aesthetic of the combined audience.

### CROSS REFERENCE TO RELATED APPLICATION

The present application is a continuation in part of U.S. patent application Ser. No. 17/308,203, filed May 5, 2021 and entitled “A METHOD AND SYSTEM FOR CUSTOMER ENGAGEMENT” the entire contents of which are hereby incorporated by reference herein.

### BACKGROUND

This invention in general relates to ecommerce, and specifically relates to a method and system of engaging with a plurality of users online.

In the current online ecommerce environment, the products and services presented to a customer are at an individual level. When presented at a group level, the preferences are mapped either to geographical coordinates or assumes generic cultural group preferences based on commonality on dimensions such as language, culture, location etc. However, in actuality, true preferences of a group are based inherently at an individual behavioural level, and when such individual preferences are aggregated, the combined preference of the group may be significantly different from simplistically derived generic group preferences.

### SUMMARY OF THE INVENTION

The method and system disclosed herein addresses the above unmet need of generating accurate style profiles of a plurality of users.

Described herein is a method and system for collective shopping wherein one or more than one person is involved in the decision making process of an online purchase.

In one aspect of the invention, a style profile is built for each individual contributor by exposing them to a set of product images and analysing their inputs about their preferences.

In another aspect of the invention, the analysis is performed at an attribute level to understand each style aesthetic in a deep and meaningful manner.

In a further aspect of the invention, a backend algorithm runs on the attribute level feedback given by each contributor to calculate their combined style performance at an attribute and product level. This input is taken and run across the annotated online catalogue to surface products that fit the style aesthetic of the combined audience.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer implemented method of generating an integrated style profile. The computer implemented method of generating also includes presenting a call to action to a first user on whether said first user wants to include a second user or a plurality of users for a collective shopping experience; interacting with said first user at an attribute or product level and generating a custom profile for the first user; interacting with said second user or each of said plurality of users at an attribute or product level and generating a custom profile for said second user or each of said plurality of users; presenting the first user with a choice via a prompt to confirm whether said second user's style profile or said plurality of user's profiles can be collectively used for said shopping experience; creating a new integrated style profile based on identified commonalities of respective custom profiles of said first user, second user, or plurality of users; and applying said integrated style profile to present a curated product to said first user. Other embodiments of this aspect include corresponding computer systems, apparatus, and computer programs recorded on one or more computer storage devices, each configured to perform the actions of the methods.

Implementations may include one or more of the following features. The method where said step of creating a new integrated style of said plurality of users further may include the steps of: determining an utility function of each of said users, u_i, u_i(b)=p(b)/(Σ_(b˜∈b) [symbol] (b˜)) where p is a probability that a user will click on a given product, and where basket, b, is a collection of attributes b=lmjm where lmjm is an attribute in learning unit m with attribute value mj; determining a group utility function, U=k=1k∪k maximizing the group utility function to optimize the basket across k users; the joint restricted space, max u b∈b B=i=1kBi where B is the joint restricted space of baskets B. The computer implemented method may include leading said first user to a dedicated web page to pursue collective shopping. Said interaction with said second user or each of said plurality of users is conducted at an attribute level. Said call to action is appended as a link on a product page of a website, where said link may be accessed directly by circumventing a prompt of said call to action. Said interaction with said second user or each of said plurality of users is conducted at a product level. Said step of creating a new integrated style profile is conducted at an attribute level. Said step of creating a new integrated style profile is conducted at a product level. Implementations of the described techniques may include hardware, a method or process, or computer software on a computer-accessible medium.

One general aspect includes a system for generating an integrated style profile of a plurality of users and presenting curated products. The system also includes at least one processor; a non-transitory computer readable storage medium communicatively coupled to said at least one processor, said non-transitory computer readable storage medium configured to store modules, said at least one processor configured to execute said modules; and where said modules may include: a call to action module for generating prompts for said users to include one more other users for collective shopping; a custom profiling module for generating custom profiles of said plurality of users; a computation module for analysing said custom profiles of each of said plurality of users; a style machine module that records analysed style profiles of each of said plurality of users, and presents product or service options to each of said plurality of users and creates an integrated style profile of the plurality of users; and a recommendation engine for generating and presenting the curated product to be displayed to said plurality of users based on said integrated style profile. Other embodiments of this aspect include corresponding computer systems, apparatus, and computer programs recorded on one or more computer storage devices, each configured to perform the actions of the methods.

Implementations may include one or more of the following features. The system where said system is a cloud-based computer system with a collection of servers. Said call to action is appended as a link on a product page of a website, where said link may be accessed directly by circumventing a prompt of said call to action. Said generation of integrated style profile of said plurality of users is conducted at an attribute level. The system may include providing a dedicated website or a weblink to pursue collective shopping. Implementations of the described techniques may include hardware, a method or process, or computer software on a computer-accessible medium.

### BRIEF DESCRIPTION OF FIGURES

FIG. 1 illustrates the method of generating collective customer preferences and presenting purchase options to the user.

FIG. 2 illustrates the system that generates collective customer preferences and that presents purchase options to the user.

FIG. 3 illustrates the overall system architecture for the system that generates collective customer preferences and that presents purchase options to the user.

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structures and devices are shown in block diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Broadly, embodiments of the present invention disclose a technique of generating an integrated style profile and presenting purchase options to the user. The technique of generating an integrated style profile and presenting purchase options to the user may be used for various products, particularly products that are purchased based on aesthetic appeal. For purposes of description of the invention, the technology will be described with reference to products in the form of items with a choice of colours. However, it is to be understood that the present technology may be applied to provide recommendations for other products such as apparel, jewellery, etc.

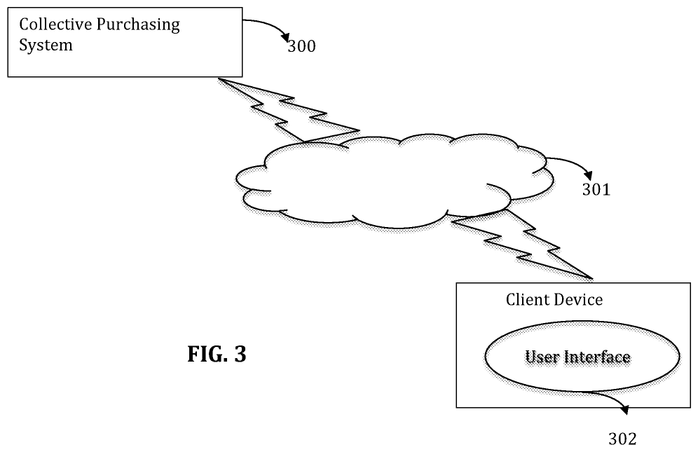

FIG. 3 illustrates the overall system architecture for the system that generates collective customer preferences and that presents purchase options to the user. The setup 300 includes a collective purchasing system 200. The system illustrated in FIG. 3 may include one or a plurality of servers deployed at a single location, or distributed geographically. For example, in one embodiment the collective purchasing system 200 may be deployed on a cloud-based computer system 301. The collective purchasing system 200 includes modules, databases, computing resources etc. necessary to implement the techniques of integrated style profile generation disclosed herein, as one of ordinary skill in the art would understand.

A client device 302 may take various forms, such as my smart phone, a tablet device, a PC, a laptop, etc. for the purposes of description, the client device 302 comprises a smart phone. Among other components, the smart phone 302 may be equipped with a user interface agent, which may take the form of a web browser. A smart phone may be communicatively coupled to an integrated style profile generation system by means of an intermediate wide area network. In one embodiment, the intermediate wide area network may represent various technologies including Internet, and wireless networking technologies.

For example, using a smart phone, the user may launch a “collective shopping application” provisioned in the smart phone which is communicatively coupled with a “collective shopping application”.

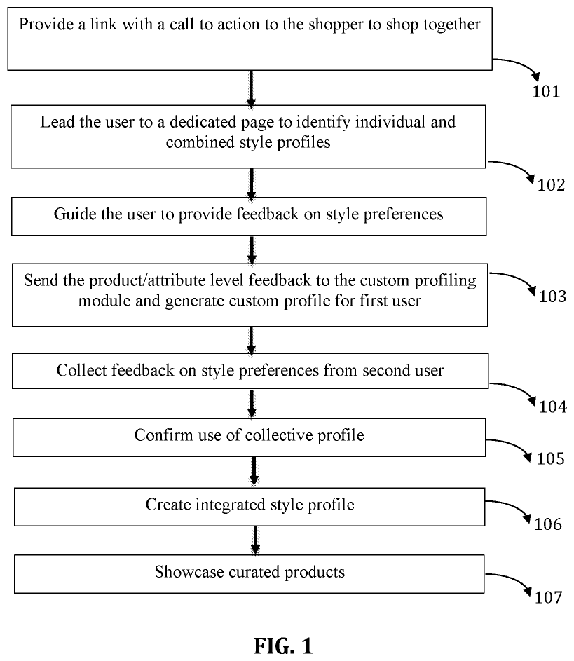

FIG. 1 illustrates the method of generating an integrated style profile and presenting purchase options to the user.

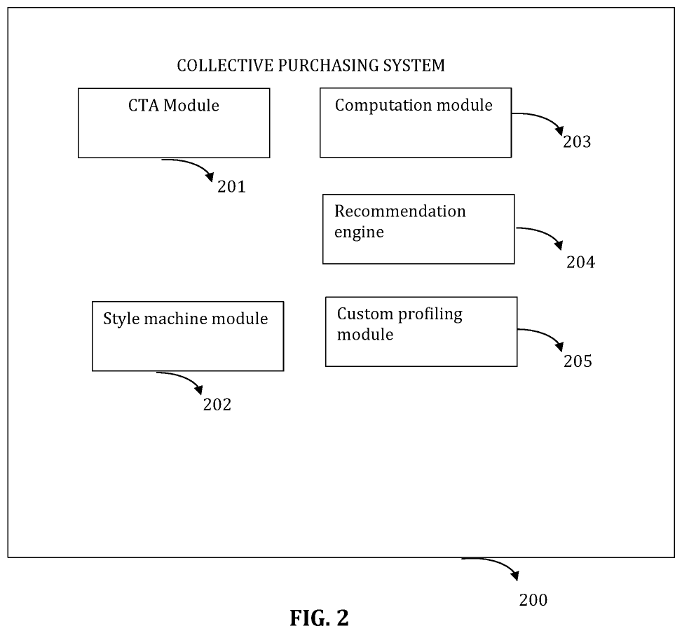

FIG. 2 illustrates the system that generates integrates style profile and that presents purchase options to the user.

When the online user lands on the target website, the call to action may provide an indication, e.g., “if you are shopping with another person, click here”. This call to action is provided as either a prompt or an announcement on the website or at any other place on the user interface, based on the choice of the online retailer providing the call to action prompt. The call to action can also be appended on a product page. For example, if a person is reviewing a product with a purchasing intent, the call to action will prompt the user to consider involving a second person for a collective shopping experience.

After the prompt is presented to the user 101, the user may opt to click on the prompt, and this takes the user to a dedicated page on the website. The website, exemplarily may be called a joint shopping or a family shopping page. The before mentioned page may be accessed directly by circumventing the first prompt, this may be available as a menu item on the top of the website or as a navigation unit for direct access without a prompt. The link will lead the user to a dedicated page 102 that will take them through the process of identifying 103 their individual and combined style of purchase.

When the user gives the consent to proceed when presented with the call to action, the style machine module 202 is activated. The style machine module 202, as a grid of products with or without an interactive engagement module, is presented to the user to engage with to provide their feedback 104. Hence, the first user is taken through the style machine module 202 with or without an interactive engagement module.

The interactive engagement module is utilized if the browsing activity is performed at an attribute level. The Interactive Engagement Module (IEM) is exposed in an engaging way to the users only when the user indicates a subtle or open interest in the entity shown either by hovering or clicking. The user has complete control over their choice to either engage or not engage with the Interactive Engagement Module. The specific attributes to be used in the IEM from the list of attributes for any entity is chosen by the owner of the ecosystem based on what they want to understand about their audience or the entity. If the browsing activity is not performed at an attribute level, the interaction is performed at a higher product level, for example with a “thumbs up” or “thumbs down” action to collect feedback on style preferences.

A user's taste profile may be determined based on quickly exposing the user to a plurality of product images, and allowing the user to interact with those images in order that the system may determine a taste profile for the user. As described, a user taste profile may be constructed based on product affinities. Additionally, in some embodiments, a product exploration process may be executed in order to uncover additional products over and beyond what would ordinarily be recommended based on product affinities. In one embodiment, during the product installation process, the user may be shown random images from a product database in order to determine the user's preference with regard to the random images. Advantageously, the random images are not selected based on product affinities. This allows the user to explore products that are not related.

Next the custom profiling module 205 is activated. The custom profiling module 205 receives the attribute or product feedback from the first user, and the custom profile for the first user is thereby generated. In a similar process as illustrated above for the first user, the second user's custom profile 104 is also generated by initiating the style machine module.

In one embodiment, a user's style profile evolves with each interaction recorded by the style machine. Advantageously, the user style profile is highly detailed and collects preference information at the attribute level (attributes are the finest level of detail in the taxonomy). The user style profile may be represented as a multi-dimensional vector that is highly sensitive to both the direction of feedback (positive/negative), and degree (e.g., feedback adjectives such as like, love, etc., as well as the count of each). Advantageously, the user style profile is determined based on the user's current preferences and used by the recommender in order to output a recommendation to the style machine. Responsive to receiving the recommendation, the style machine changes the image associated with the slot in respect of which user input has been received.

Taxonomy provides structure to the data set to ‘sample’ from and collect feedback from the user on. In some embodiments, the taxonomy may include additional dimensions such as price. User feedback against these attributes are used to create the user style profile (also referred to herein as a “user taste profile”). In some embodiments, for large dimensions like ‘Retailer/Brand’ shown above, each dimension may be broken down into sub-groups. This allows the recommendation technology described herein to work more efficiently to test for a user's taste. For example, if a user responds negatively to brands in the ‘Affordable Traditional’ sub-group, the sub-group can be eliminated from further exploration without having to test every leaf on that branch.

A taxonomy similar to the above may be developed for other data sets. For each taxonomy, a set of mutually exclusive dimensions that collectively exhaust the attribute consideration set is required. By structuring the data in this way, the recommendation technology described herein can efficiently test the boundaries of the solution space before quickly narrowing in on the best possible solutions for the user.

The recommendation technique of the present invention may be used for various products, particularly products that are purchased based on aesthetic appeal. For purposes of description of the invention, the technology will be described with reference to products of apparel. In particular, the use case where a customer wishes to furnish a particular space/room will be described. However, it is to be understood that the present technology may be applied to provide recommendations for other products such as furniture, jewellery, etc.

After the style profile of the second user is generated, the CTA module 201 is again initiated, and a confirmation prompt 105 is generated to create an integrated style profile 106 for use in the current session of the user. The CTA module 201 presents the first user with a choice to confirm that if the second user's style profile can be collectively used, and if any other user's style preferences need to be added.

In this section we highlight an application to determining group preferences and integrated style profiles. Suppose we are looking to determine a group preference for k distinct users I.

The space of products is approximated to be a finite dimensional vector space. The standard basis for this space is defined to be a collection of all learning units. Hence, every product can be defined uniquely using only the learning units. For every product P and every learning unit L, there exists a unique 1′ in L such that p is the intersection of all 1′. The space of all products can be approximated by the collection of all attributes. Group some attributes together and consider it as a coordinate axis on the before mentioned space. A single learning unit may be represented as a single coordinate axis on the space, and the collection of all coordinate axes represents the entire product space.

Assume n distinct learning units, L.

Furthermore ∀l∈L ∃m distinct attributes {l₁, l₂, . . . , lₘ}. Define a Basket, b, to be a collection of attributes

$$b = ( {l}_{{j}_{}}^{} )$$

where [symbol] is an attribute in learning unit [symbol] with attribute value [symbol] . Recall above that a user's individual preference could be determined via an application of Bayes Rule. In particular, the probability that a user will click on a given product is determined. This defines a rank order over the space of Baskets, B. For any user, i∈I, define a utility function, Uᵢ,

$${U}_{i} ( b ) = \frac{P ( b )}{P ( )}$$

where, P(b), is the click probability defined earlier. Further define the group utility function,

$$U = {k}^{}$$

To find the optimal basket across k users, maximize the group utility function,

$${max}_{b ∈ B} U$$

As the joint utility function needs to be maximized, when players want to consider only a subset of the universe of baskets, first determine for each player, i, the restricted space of baskets, [symbol] .

Next, consider the joint restricted space,

$$= {\prod }_{i = 1}^{k} {i}_{}$$

To find the optimal basket across k users, maximize the group utility function on the restricted space,

$$U$$

Another situation to consider is when certain individuals in the group have more influence in the decision making process. In this case individual utility functions are weighted accordingly. Consider again the restricted space, [symbol] . Define individual weights, 0≤wᵢ≤1 and,

$${\sum }_{i = 1}^{k} {w}_{i} = 1$$

In this situation we consider the weighted joint utility function,

$${U}_{w} = \cdot$$

To consider both situations of restricted baskets and variable utility, solve following maximization equation,

$${U}_{w}$$

Once the CTA module 201 receives the confirmation on the number of profiles 105 to be collectively used, the computation module 203 runs the algorithm to analyse the style profile of the first and second user, or a plurality of users, and creates a new integrated style profile 106 based on the identified commonalities at an attribute level and the derived insights.

After the first user confirms that the integrated profile can be used in the current session, the integrated profile is fed into either a dynamic catalogue delivery engine or a recommendation engine 204. Finally, a curated product is showcased to the first user 107.

Bayes Rule to is applied to predict various user actions (Click, Cart, Hover) conditioned on every pair and every possible tuple across all co-occurring learning unit attributes for shown products.

Predictions are quantified using conditional probabilities and furthermore determine a ranked order of combinations for recommender and discovery modes. In the discovery mode, consider the probability of a user action for combinations in the same hierarchy with the leaf node being the discovery product. Final rank of combinations is a weighted aggregate over all user actions (e.g., if a particular combination is clicked and carted then it would have a higher aggregate value then the same combination only being clicked).

The processing steps described above may be implemented as modules. As used herein, the term “module” might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. After reading this description, it will become apparent to a person skilled in the relevant art how to implement the invention using other computing modules or architectures.

In general, the modules/routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks, flash drives among others.

Modules might be implemented using a general-purpose or special-purpose processing engine such as, for example, a microprocessor, controller, or other control logic. In the illustrated example, the modules could be connected to a bus, although any communication medium can be used to facilitate interaction with other components of computing modules or to communicate externally.

The computing server might also include one or more memory modules, simply referred to herein as main memory. For example, preferably random access memory (RAM) or other dynamic memory, might be used for storing information and instructions to be executed by processor. Main memory might also be used for storing temporary variables or other intermediate information during execution of instructions to be executed by a processor. Computing module might likewise include a read only memory (“ROM”) or other static storage device coupled to bus for storing static information and instructions for processor.

The database module might include, for example, a media drive and a storage unit interface. The media drive might include a drive or other mechanism to support fixed or removable storage media. For example, a hard disk drive, a floppy disk drive, a magnetic tape drive, an optical disk drive, a CD, DVD or Blu-ray drive (R or RW), or other removable or fixed media drive might be provided. Accordingly, storage media might include, for example, a hard disk, a floppy disk, magnetic tape, cartridge, optical disk, a CD, DVD or Blu-ray, or other fixed or removable medium that is read by, written to or accessed by media drive. As these examples illustrate, the storage media can include a computer usable storage medium having stored therein computer software or data.

In alternative embodiments, the database modules might include other similar instrumentalities for allowing computer programs or other instructions or data to be loaded into the computing module. Such instrumentalities might include, for example, a fixed or removable storage unit and an interface. Examples of such storage units and interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module.

The communications module might include various communications interfaces such as an Ethernet, network interface card, WiMedia, IEEE 802. XX or other interface), or other communications interface. Data transferred via communications interface might typically be carried on signals, which can be electronic, electromagnetic (which includes optical) or other signals capable of being exchanged by a given communications interface. These signals might be provided to communications interface via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer implemented method of generating an integrated style profile, comprising:
presenting a call to action to a first user on whether said first user wants to include a second user or a plurality of users for a collective shopping experience;
interacting with said first user at an attribute or product level and generating a custom profile for the first user;
interacting with said second user or each of said plurality of users at an attribute or product level and generating a custom profile for said second user or each of said plurality of users;
presenting the first user with a choice via a prompt to confirm whether a style profile of said second user or a style profile of said plurality of users can be collectively used for said shopping experience;
creating a new integrated style profile based on identified commonalities of respective custom profiles of said first user, second user, or plurality of users; and
applying said integrated style profile to present a curated product to said first user.

2. The method of claim 1, wherein said step of creating a new integrated style of said plurality of users further comprises the steps of:
determining an utility function of each of said users, U_i, wherein
$${U}_{i} ( b ) = \frac{P ( b )}{P ( )}$$
and wherein P is a probability that a user will click on a given product, and wherein basket, b, is a collection of attributes
$$b = ( )$$
where [symbol] is an attribute in learning unit [symbol] with attribute value [symbol] ;
determining a group utility function, U, wherein
U= [symbol] [symbol] ; and
maximizing the group utility function by performing the operation
$$U$$
to optimize the basket across K users on a joint restricted space, wherein [symbol] =Πᵢ₌₁^{k} [symbol] , and wherein [symbol] is the joint restricted space of baskets [symbol] .

3. The computer implemented method of claim 1, further comprising leading said first user to a dedicated web page to pursue collective shopping.

4. The computer implemented method of claim 1, wherein said interaction with said second user or each of said plurality of users is conducted at an attribute level.

5. The computer implemented method of claim 1, wherein said call to action is appended as a link on a product page of a website, wherein said link may be accessed directly by circumventing a prompt of said call to action.

6. The computer implemented method of claim 1, wherein said interaction with said second user or each of said plurality of users is conducted at a product level.

7. The computer implemented method of claim 1, wherein said step of creating a new integrated style profile is conducted at an attribute level.

8. The computer implemented method of claim 1, wherein said step of creating a new integrated style profile is conducted at a product level.

9. A system for generating an integrated style profile of a plurality of users and presenting curated products, comprising:
at least one processor;
a non-transitory computer readable storage medium communicatively coupled to said at least one processor, said non-transitory computer readable storage medium configured to store modules, said at least one processor configured to execute said modules; and wherein said modules comprise:
a call to action module for generating prompts for said users to include one more other users for collective shopping;
a custom profiling module for generating custom profiles of said plurality of users;
a computation module for analysing said custom profiles of each of said plurality of users;
a style machine module that records analysed style profiles of each of said plurality of users, and presents product or service options to each of said plurality of users and creates an integrated style profile of the plurality of users; and
a recommendation engine for generating and presenting the curated product to be displayed to said plurality of users based on said integrated style profile.

10. The system of claim 9, wherein said system is a cloud-based computer system with a collection of servers.

11. The system of claim 9, wherein said call to action is appended as a link on a product page of a website, wherein said link may be accessed directly by circumventing a prompt of said call to action.

12. The system of claim 9, wherein said generation of integrated style profile of said plurality of users is conducted at an attribute level.

13. The system of claim 9, wherein said generation of integrated style profile of said plurality of users is conducted at a product level.

14. The system of claim 9, further comprising providing a dedicated website or a weblink to pursue collective shopping.
